(19) United States
(12) Patent Application Publication
(10) Pub. No.: US 2018/0054140 A1
(43) Pub. Date: Feb. 22, 2018

(54) INTERFACE CONVERTER COMMON MODE VOLTAGE CONTROL

(71) Applicant: Virginia Tech Intellectual Properties, Inc., Blacksburg, VA (US)

(72) Inventors: Fang Chen, Blacksburg, VA (US); Rolando Burgos, Blacksburg, VA (US); Dushan Boroyevich, Blacksburg, VA (US)

(73) Assignee: Virginia Tech Intellectual Properties, Inc., Blacksburg, VA (US)

(21) Appl. No.: 15/242,683

(22) Filed: Aug. 22, 2016

(51) Int. Cl. H02M 7/70; H02M 1/44; H02M 7/797

(52) U.S. Cl. CPC H02M 7/70; H02M 7/797; H02M 1/44

(57) ABSTRACT

Aspects of interface converter common mode (CM) voltage control are described. In one embodiment, a bi-directional alternating current (AC) to direct current (DC) interface converter system includes an AC-DC converter between an AC power system and an interface link and a DC-DC converter between a DC power system and the interface link. The AC-DC converter can include a bridge converter having power switches, such as field-insulated gate bipolar transistors (IGBTs) or another power semiconductor device. The system also includes a control loop that generates control signals for switching the power switches of the AC-DC converter, and a CM control loop that injects a CM control signal into the control loop. By injecting the CM control signal into the control loop, low-frequency ripple and asymmetry between positive and negative output voltages of the DC power system can be reduced.

### BACKGROUND

Renewable energy sources like solar and wind are contributing more to the generation of electricity. The reliance on renewable energy sources has also led to the use of integrated energy storage devices to buffer the intermittent generation of energy. With emerging installations of renewable energy sources and energy storage devices, direct current (DC) distribution systems in residential houses, commercial buildings, etc. are becoming a relied-upon solution. DC grids, nanogrids, microgrids, etc. are being used to connect to renewable energy sources and renewable energy storage devices because of the relatively higher efficiency and reliability under certain circumstances.

DC grids can be connected to alternating current (AC) utility grids through interface converter systems to exchange energy between them. Interface converter systems include grid-interface bidirectional AC-DC power converter systems and devices. Besides the basic function of power conversion between the DC and AC utility grids, interface converter systems should fulfill power quality and electromagnetic interference regulations on both DC and AC sides.

### BRIEF DESCRIPTION OF THE DRAWINGS

Many aspects of the present disclosure can be better understood with reference to the following drawings. The components in the drawings are not necessarily drawn to scale, with emphasis instead being placed upon clearly illustrating the principles of the disclosure. In the drawings, like reference numerals designate corresponding parts throughout the several views.

FIG. 1 illustrates a schematic of a residential DC nanogrid, an AC utility grid, and an interface converter system according to various examples described herein.

FIGS. 2A and 2B illustrate example interfaces and grounding schemes of AC and DC distribution systems, respectively, according to various examples described herein.

FIG. 3 illustrates a two-stage bidirectional single-phase AC-DC interface converter system according to various examples described herein.

FIG. 4 illustrates example DC bus voltages to ground after adding a floating common mode (CM) filter to the interface converter system shown in FIG. 3 according to various examples described herein.

FIGS. 5A and 5B illustrate low-frequency circuit models of the interface converter system shown in FIG. 3 without EMI filters according to various examples described herein.

FIG. 6 illustrates the impact from the DC-link voltage on the CM duty cycle injection according to various aspects of the embodiments.

FIG. 7 illustrates the impact from the AC voltage on the CM duty cycle injection according to various aspects of the embodiments.

FIG. 8 illustrates an example time domain simulation according to various aspects of the embodiments.

FIG. 9 illustrates an example duty cycle before and after enabling CM voltage control for the example simulation shown in FIG. 8 according to various aspects of the embodiments.

FIG. 10 illustrates an example time domain simulation with a 380 V DC-link voltage and a 120 V asymmetric AC input according to various aspects of the embodiments.

FIG. 11 illustrates an example duty cycle before and after enabling CM voltage control for the example simulation shown in FIG. 10 according to various aspects of the embodiments.

FIG. 12 illustrates an example equivalent circuit of the interface converter system shown in FIG. 3 with the floating filter according to various aspects of the embodiments.

FIG. 13 illustrates the measured power stage transfer function from the CM duty cycle to the negative DC bus voltage compared with the modeled result according to various aspects of the embodiments.

FIG. 14 illustrates measured compared to modeled results for the loop gain with resonant controller according to various aspects of the embodiments.

FIG. 15 illustrates three-phase cascaded AC-DC interface converter system according to various examples described herein.

FIG. 16 illustrates an example time domain simulation for a three-phase front-end according to various aspects of the embodiments.

FIG. 17 illustrates a schematic diagram of an empirical test setup using a single-phase bidirectional AC-DC converter according to various aspects of the embodiments.

FIGS. 18 and 19 illustrate steady-state AC voltage, AC current, and positive and negative DC bus voltages, with and without the CM voltage control, respectively, for the empirical test setup according to various aspects of the embodiments.

FIGS. 20 and 21 illustrate the transition between rectifier and regeneration modes with and without the CM control, respectively, for the empirical test setup according to various aspects of the embodiments.

FIG. 22 illustrates AC side current start and end points with and without the CM control in an example case according to various aspects of the embodiments.

FIGS. 23A-23G illustrate example topologies and designs of interface converter systems used between different types of electrical systems according to various aspects of the embodiments.

### DETAILED DESCRIPTION

As noted above, renewable energy sources like solar and wind are contributing more to the generation of electricity. The reliance on renewable energy sources has also led to the use of integrated energy storage devices to buffer the intermittent generation of energy. With emerging installations of renewable energy sources and energy storage devices, direct current (DC) distribution systems in residential houses, commercial buildings, etc. are becoming a relied-upon solution. DC grids, nanogrids, microgrids, etc. are being used to connect to renewable energy sources and renewable energy storage devices because of the relatively higher efficiency and reliability under certain circumstances. DC grids can be connected to alternating current (AC) utility grids through interface converter systems to exchange energy between them.

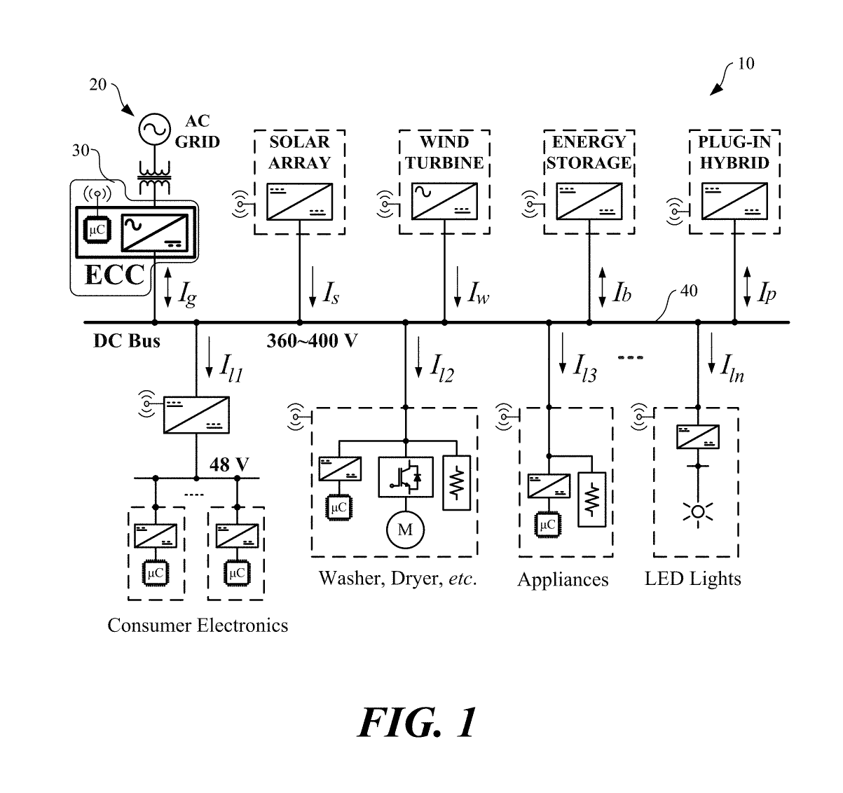

FIG. 1 illustrates a schematic of a residential DC nanogrid 10, an AC utility grid 20, and an interface converter system 30 according to various examples described herein. As shown in FIG. 1, renewables, energy storage, and different kinds of loads are connected to a common DC bus 40 through various power converters. The DC nanogrid 10 is interfaced with the AC utility grid 20 through an AC-DC interface converter called the energy control center (ECC) 30. The ECC 30 regulates bidirectional power flow between the DC nanogrid 10 and the AD utility grid 20, regulates the currents and voltages between them, and decouples the dynamics of the interconnected systems. The grounding scheme is important when connecting the DC nanogrid 10 and the AC utility grid 20, and various options are available for a common grounding scheme among them.

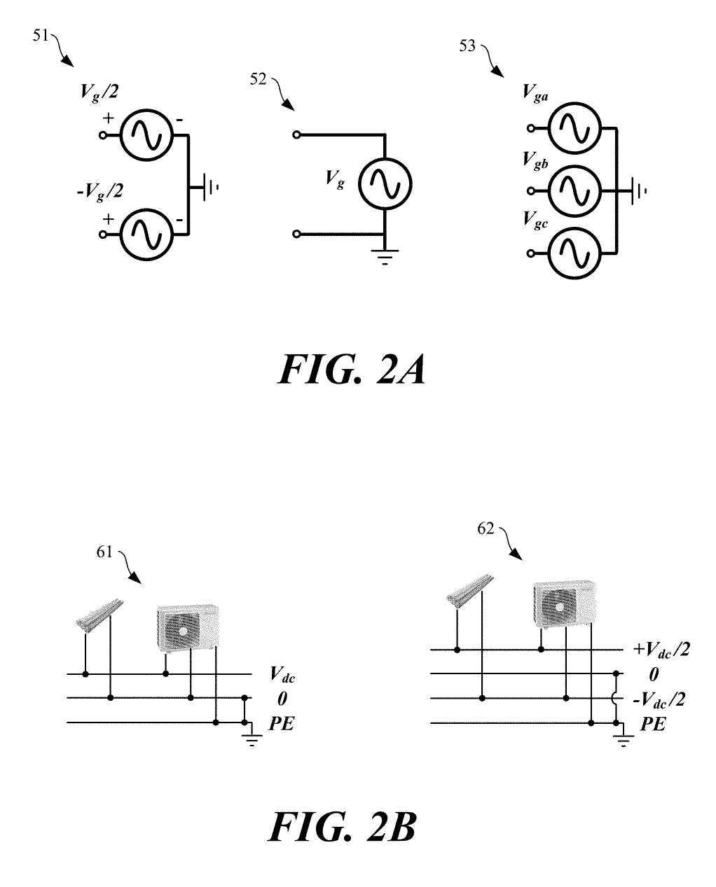

FIGS. 2A and 2B illustrate example interfaces and grounding schemes of AC and DC distribution systems, respectively, according to various examples described herein. In FIG. 2A, three typical single-phase and three-phase ac interfaces are drawn. In North America, the most common residential interface is the 120 V split-phase system 51. The phase to neutral voltage is 120 Vrms which feeds lighting and plug loads. The line to line voltage is 240 V for heavy loads such as heaters, electric ranges, and air conditioners. FIG. 2A also illustrates an asymmetric single-phase system 52. The asymmetric single-phase system 52 can be drawn from one phase of a three-phase transformer and can provide electricity to a number of residences, as is the current practice in China, for example. The asymmetric single-phase system 52 can also be provided as a single wire earth return system as often used in rural areas to save one transmission line. The three-phase system 53 is broadly used in European residential buildings. It is also used in higher power applications, like commercial buildings around the world.

As for DC distribution systems, different voltage levels and grounding schemes exist because of the relative lack of standards. One broadly accepted configuration is to use a 380 VDC nominal voltage for home appliances and 48 V for telecommunication equipment, as shown in FIG. 1, although other voltages and voltage ranges can be used. The grounding can be achieved in a unipolar configuration 61 or a bipolar configuration 62 as shown in FIG. 2B. The protective earth (PE) is for safety and is usually connected to the surfaces of appliances, for example. The unipolar configuration 61 only requires two lines for the power transmission. From a safety point of view, however, the bipolar configuration 62 uses a third line for grounding. The voltage on the positive and negative sides of the DC bus in the bipolar configuration 62 is only half of the total DC bus voltage which reduces the hazard to human safety.

Transformer-less bidirectional AC-DC interface converter systems have been proposed to connect DC nanogrids to AC utility grids. Compared with isolated topologies, the non-isolated topology of the transformer-less bidirectional AC-DC interface converter systems is simpler and generally more efficient. One main concern with transformer-less systems is circulating common-mode (CM) current, also called ground leakage current. In transformer-less systems, CM current flows between the DC and AC grids through the common ground between them. The leakage current introduces extra loss and accelerates the ageing of electrical components. CM voltage and stray current are related to each other by the grounding impedance. For a high ground impedance, there may be less stray CM current but the CM voltage may take its maximum value. On the contrary, if the system is solidly grounded, there will be relatively low or no CM voltage, but the stray current can take its maximum value. The design of a proper grounding scheme must consider these trade-offs.

The CM current can be evaluated separately in high and low-frequency ranges. In the high-frequency range, because the parasitic impedance to the ground is small, the voltage excitation generates a noticeable ground leakage current. This value is limited by safety and EMI standards. This problem is especially severe in photovoltaic (PV) cell applications where the parasitic capacitance from the cells to the frame and ground is large. In motor drive applications, the leakage current flows through the stator and rotor of the machine and reduces the lifetime of the bearings.

A significant amount of research has been conducted to mitigate various CM problems in high-frequency ranges. These methods either reduce the noise source or increase the impedance of the transmission path. Various improvements can be achieved through topology, modulation, and filter design. Certain topologies have been designed to reduce the CM noise in PV applications. In another case, a fourth phase leg was added to a three-phase converter to eliminate the CM voltage. In still another case, different modulation schemes were proposed to limit the variations of the CM voltage and reduce the CM noise. A closed-loop gate control has also been used to control the switching speed and limit electro-magnetic-interference. Changing the transmission path is another way to mitigate CM problems. Traditional filters increase the path impedance so the measured output noise is reduced. On the other hand, floating filters can be used in motor drive applications to create a low impedance path within the converter and trap the noise the converter instead of emitting to the output.

Compared to the level of research conducted to solve CM problems in high-frequency ranges, not as much research has been conducted on low-frequency CM voltage control. The parasitic impedance to ground at low-frequency is usually high so the ground leakage current is not as severe. But, this issue becomes important when two grounded systems are connected, especially through a non-isolated power converter. If the low-frequency CM voltage is not properly controlled, a continuous DC or low-frequency AC current circulates between the two systems through the ground.

In the context outlined above, active CM duty cycle injection concepts are described herein. The concepts can be used to control DC and low-frequency (e.g. double-line-frequency) CM voltage for grounded interconnected power converter systems. For example, CM duty cycle injection can be used to control DC and low-frequency CM voltage offsets between a DC nanogrid interconnected with a single-phase ac grid using a transformerless AC-DC converter. In such configurations, the AC and DC CM voltages can be coupled through the ground. While high-frequency noise is filtered by passive networks, for example, the DC and low-frequency CM voltages should be controlled to generate symmetric DC bus voltages and reduce ground leakage current. Using a two-stage bidirectional AC-DC converter as an example, the operating range of the proposed CM duty cycle injection concepts is described with different operating voltages and grounding schemes. A CM transfer function is also derived with a detailed CM circuit model and verified by measurements. Experiments with resistive and constant power loads in rectifier and regeneration modes validate the performance and stability of the control concepts. As a result, the DC bus voltages are relatively more symmetric to the ground and the leakage current is reduced. The control concepts can also be applied to three-phase cascaded interface converters.

Thus, an active CM duty cycle injection method is described herein to reduce low-frequency CM voltage ripple and generate symmetric DC bus voltages. The operating range of the CM duty cycle injection is identified. The impact from the AC voltage, DC-link voltage and AC grounding method is analyzed. A CM circuit model is derived using a single-phase example to get the transfer function from the CM duty cycle to the DC bus CM voltage. A control loop is then designed and verified by transfer function measurement. The control method is generalized to three-phase cascaded AC-DC converters. Experiment waveforms are provided to demonstrate the CM voltage regulation and ground leakage current reduction. Constant power load and bidirectional power flow are also considered in the experiments to demonstrate the robustness of the proposed method. Finally, the impact on the AC side inductor current is shown and explained in the end.

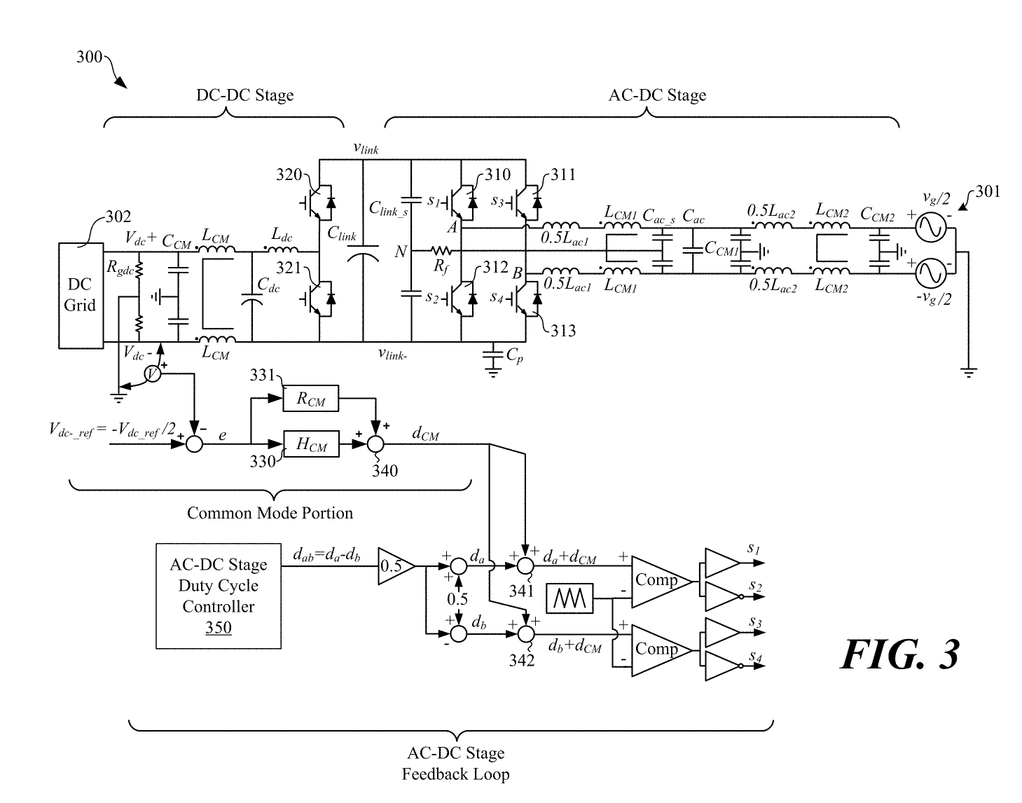

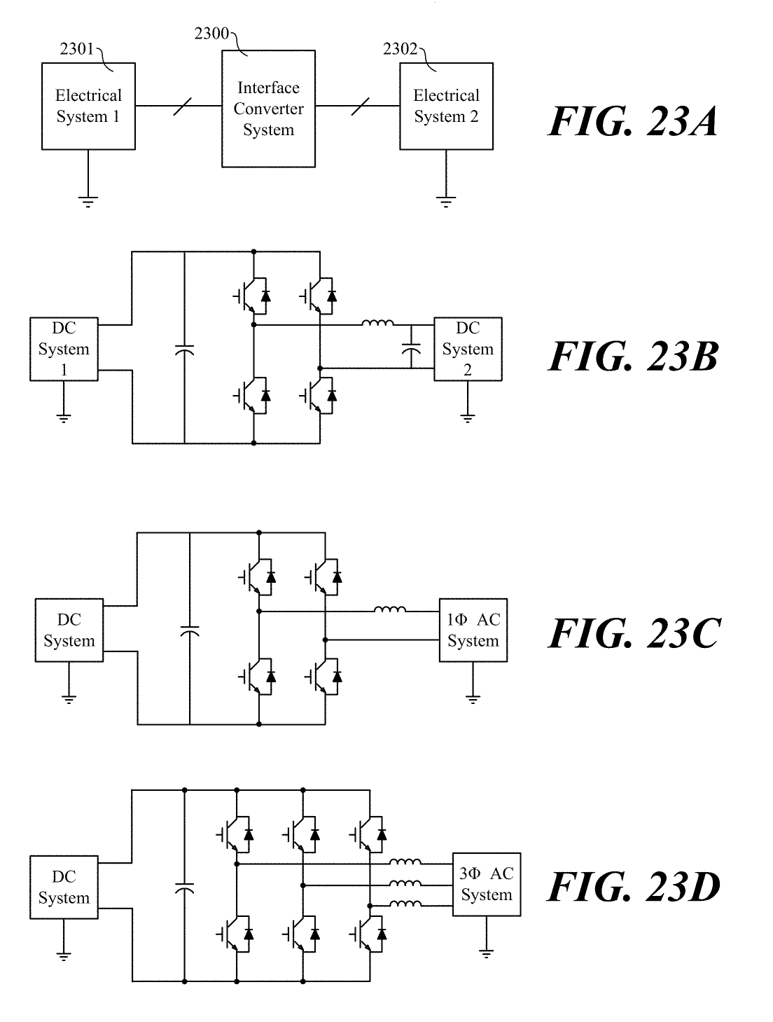

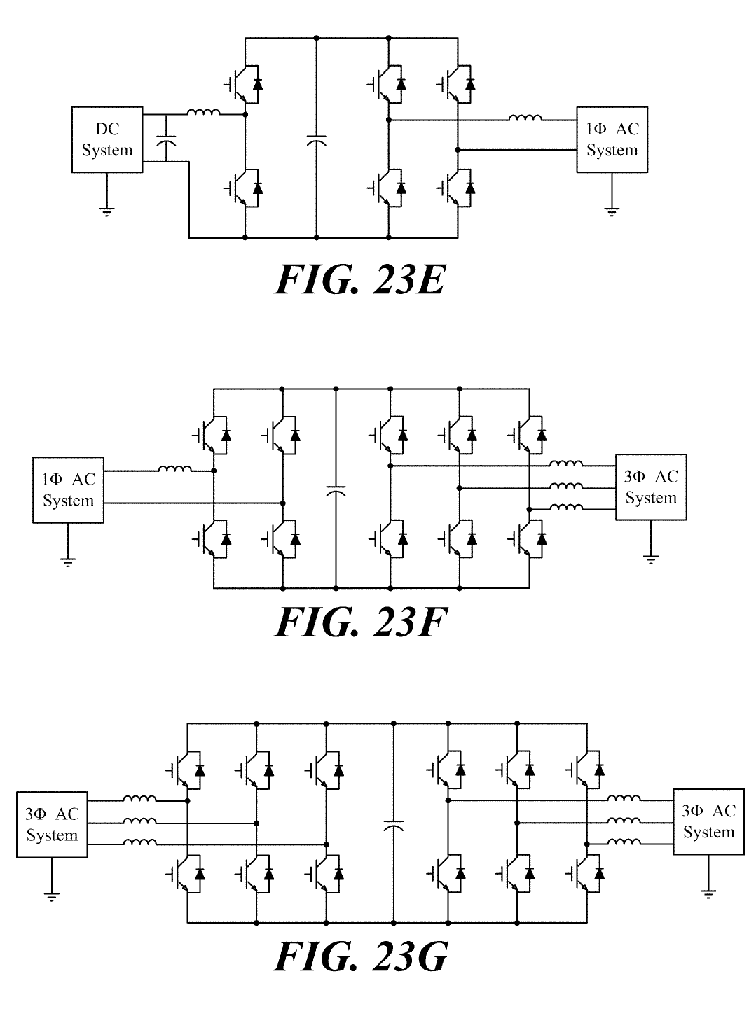

FIG. 3 illustrates a two-stage bidirectional AC-DC interface converter system 300 (also “system 300”) according to various examples described herein. Before turning to a more detailed description, it is noted that the system 300 is provided as a representative example to describe the concepts of CM voltage control. The aspects of CM voltage control described herein can be applied to other topologies and designs of interface converter systems besides that shown in FIG. 3, such as any of those shown in FIGS. 23A-23G, among others. Generally, the aspects of CM voltage control described herein can be applied to any interface converter system between any two or more electrical systems (DC and/or AC systems), operating at any suitable AC- and DC-side voltages, to address the problem of ground leakage current (among other, similar problems). As one example, the aspects of CM control described herein can be applied to the AC-DC interface converter systems described in U.S. Pat. No. 9,071,141 (“the '141 patent”), titled “Two-stage Single Phase Bi-directional PWM Power Converter with DC link Capacitor Reduction,” the entire contents of which are hereby incorporated herein by reference.

Referring again to FIG. 3, the system 300 includes a DC-DC stage and an AC-DC stage. The system 300 is electrically coupled on the AC side to the split-phase 120 Vrms AC grid 301 having a grounded midpoint (e.g. as is the U.S. residential utility). On the DC side, the system 300 is electrically coupled to a DC bipolar nanogrid 302 with high resistance midpoint grounding (HRMG). A full-bridge (e.g., “H-bridge”) converter on the AC-DC stage side is cascaded with a bidirectional buck converter on the DC-DC stage side. An interface link capacitance Cₗᵢₙₖ_{_}ₛ is electrically coupled between the full-bridge converter of the AC-DC stage and the buck converter of the of the DC-DC stage. By allowing a large voltage ripple on the intermediate DC-link (e.g., vₗᵢₙₖ at the link capacitance Cₗᵢₙₖ_{_}ₛ) the required capacitance to store the double-line-frequency ripple power is significantly reduced. This topology of the system 300 can also limit the short circuit current if the AC or DC port is shorted. To reduce the volume of the AC inductors L_{ac1} and L_{ac2}, unipolar modulation can be used.

As shown in FIG. 3, the AC-DC stage side includes full-bridge insulated gate bipolar transistors (IGBTs) 310-313, the AC-side inductor pairs L_{ac1} and L_{ac2}, and the capacitor C_{ac}. The DC-DC stage side includes the buck converter IGBTs 320-321, the DC-side inductor L_{dc}, and the capacitor C_{dc}. In various embodiments, the full-bridge and buck converters include any suitable type of power semiconductor devices, such as power bipolar transistors, power metal oxide semiconductor field effect transistors (MOSFETs), or power IGBTs for switching power.

Because the system 300 is representative, it should be appreciated that certain elements can be omitted from those shown in FIG. 3 and other elements can be added (or are simply omitted from view in FIG. 3). For example, a switching controller for the IGBTs 320-312 of the buck converter is omitted from view so as not to detract from the concepts of interface converter common mode voltage control described herein. Any suitable switching controller for the IGBTs 320-321 can be used in the embodiments, including those described in the '141 patent, for example.

One concern with the system 300 is circulating CM current, also called ground leakage current. In the system 300, CM current flows through the common ground between the AC grid 301 and the DC bipolar nanogrid 302. The ground leakage current includes both high and low frequency components. To help address or mitigate the ground leakage current, the AC-DC stage of the system 300 incorporates a floating CM filter including the CM choke L_{CM1} and split CM capacitors C_{ac}_{_}ₛ. As shown in FIG. 3, the midpoint of the CM capacitors C_{ac}_{_}ₛ is not connected to ground but to the midpoint of the DC-link node N through a damping resistor R_{f}. Because of the impedance (Z) mismatch (e.g., Z(C_{ac}_{_}ₛ)<<Z(L_{CM2})), a significant amount of high-frequency noise is contained or filtered out within the floating CM filter loop. The floating CM filter not only avoids the interaction between the AC and DC CM filters but it also reduces the filter volume by allowing a larger C_{ac}_{_}ₛ. Additional non-floating CM filter elements, such as the L_{CM}, L_{CM2}, C_{CM}, C_{CM1}, and C_{cM2} elements, can also be included in the system 300 to help reduce the high frequency common mode noise. The differential mode (DM) inductors are put in a symmetric way to reduce the coupling between DM and CM quantities. Cₚ is the equivalent parasitic capacitance between the power device and the ground.

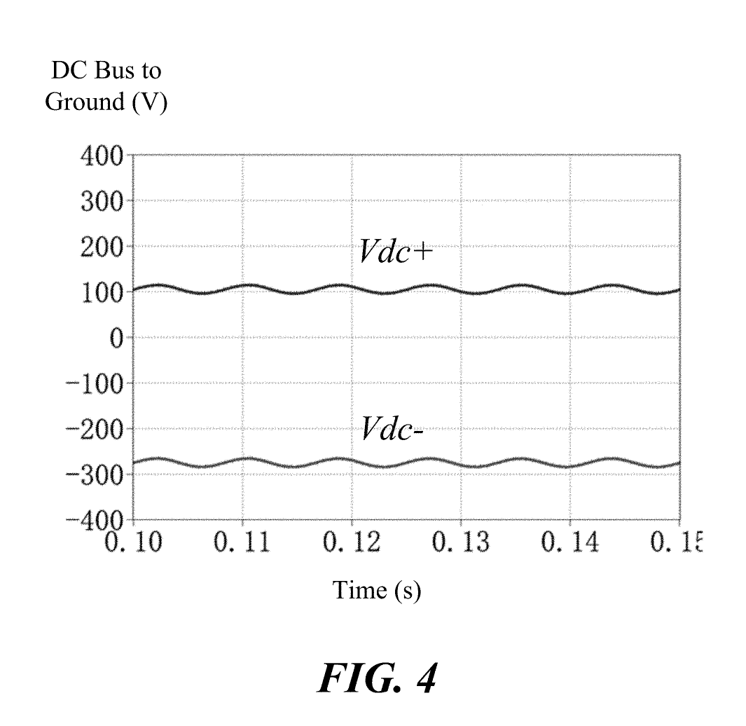

While the floating (and non-floating) CM filter loop can help to reject a significant amount of high-frequency noise from the ground leakage current, it might fail to address (or lead to) other effects in the system 300. For example, FIG. 4 illustrates simulated DC bus voltages to ground at the DC bipolar nanogrid 302 (i.e., the positive Vdc+ and negative Vdc− DC bus voltages) after adding the floating CM filter to the system 300 shown in FIG. 3. As shown, the high-frequency components are substantially filtered out, but low-frequency ripple still exists on the DC bus voltages. Additionally, the positive Vdc+ and negative Vdc− DC bus voltages are not symmetric to ground (e.g., 0V) because only the positive DC-link is modulated by the DC-DC stage.

To generate a symmetric DC bus voltage at the DC bipolar nanogrid 302 without (or with significantly reduced) low-frequency CM voltage ripple, CM voltage control is injected into the feedback control loop of the AC-DC stage according to aspects of the embodiments. The addition of the CM voltage control into the feedback loop adjusts the CM voltage at the DC bipolar nanogrid 302 by changing the CM voltage of the AC-DC stage. When the negative Vdc− DC bus voltage is controlled to be half of the positive DM DC bus voltage (Vdc/2 or (Vdc+ minus Vdc−)/2) below ground, the positive Vdc+ DC bus voltage is half of the DC bus voltage above the ground. In other words, the positive Vdc+ and negative Vdc− DC bus voltages are symmetric about the ground voltage for the DC bipolar nanogrid 302. Since the interface converter system 300 is a closed-loop system, the feedback loop also suppresses low-frequency voltage ripple that exists in single-phase AC-DC conversion.

In the CM portion of the AC-DC stage feedback loop, error e between the sensed negative Vdc− DC bus voltage and its reference (e.g., V_{dc-}_{_}_{ref}) is passed through a CM voltage controller 330. As described in greater detail below, the CM voltage controller 330 (H_{CM}) can be embodied as any suitable type of controller, such as a proportional integral derivative (PID) controller, a proportional integral (PI) controller, or a multi-pole multi-zero controller. To be distinguished from a proportional resonant (PR) controller, for example, or other types of controllers, the CM voltage controller 330 can include an integrator to accurately control the DC offset of the DC bus voltage.

As shown in FIG. 3, the CM voltage controller 330 can be coupled in parallel with a resonant controller 331 (R_{CM}). The resonant controller 331 is configured to suppress the double-line-frequency CM voltage ripple (e.g., at 120 Hz) on the DC bus. In the embodiment shown in FIG. 3, the combination of the outputs of the CM voltage controller 330 and the resonant controller 331, as summed by the summer 340, form the CM control signal d_{CM}.

The system 300 also includes an AC-DC duty controller 350 configured to determine a switching duty cycle d_{ab} for the full-bridge IGBTs 310-313 of the AC-DC stage. In the AC-DC stage feedback loop, the switching duty cycle d_{ab} is split-shifted into the duty cycle signals dₐ and d_{b}, respectively, for the two phase legs of the full-bridge IGBTs 310-313 of the AC-DC stage. The summers 341 and 342, respectively, add or inject the control signal d_{CM} to the duty cycle signals dₐ and d_{b}, forming the control signals dₐ+d_{CM} and d_{b}+d_{CM}. As shown in FIG. 3, the control signal d_{CM} is added to both the duty cycle signals dₐ and d_{b}. Thus, the switching-cycle-averaged differential-mode (DM) voltage between the two phase legs does not change. The control of the DM AC current is not affected while the CM voltage is regulated by the extra loop.

Because the proposed method uses extra control freedom of the AC-DC stage phase legs to control the CM voltage, the amount of available room for the injection of the CM voltage into the duty cycle signals dₐ and d_{b} is important to the operation of the AC-DC stage feedback loop. Since the injection target is to control the low-frequency CM voltage, a low-frequency circuit model without EMI filters can be used to identify the operating range.

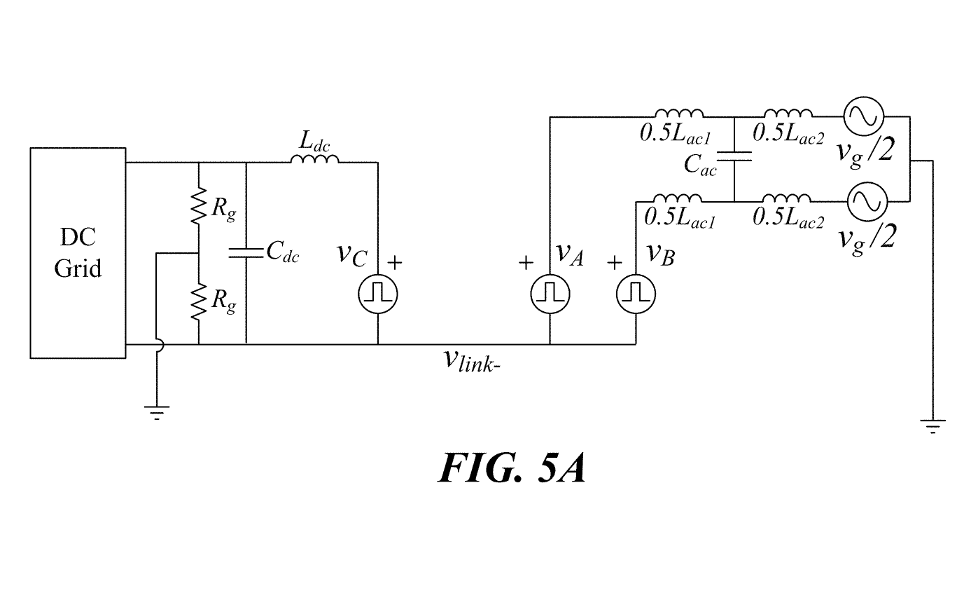

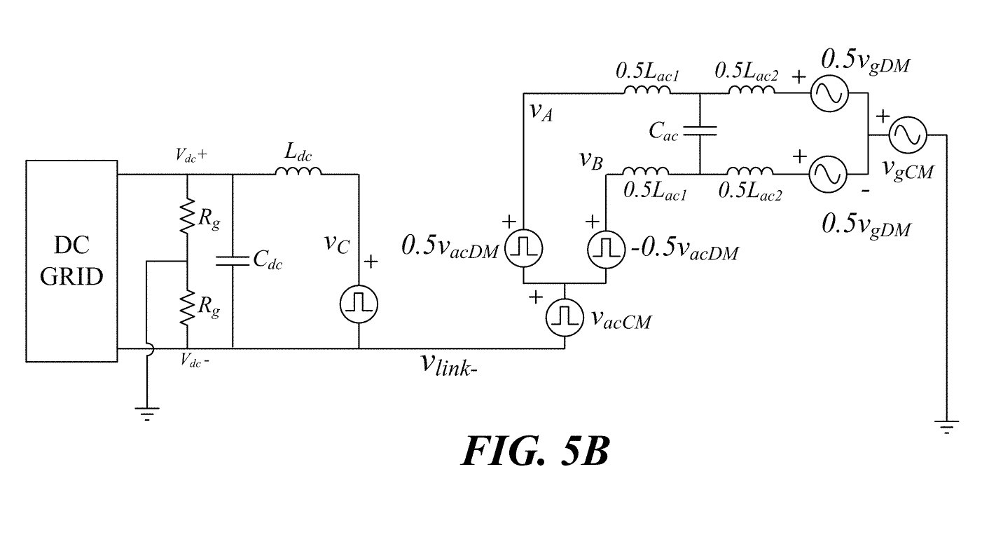

FIGS. 5A and 5B illustrate low-frequency circuit models of the interface converter system 300 shown in FIG. 3. As shown in FIG. 5A, the phase legs are replaced with equivalent voltage sources v_{A}, v_{B} and v_{C}, defined as:

v_{A}=dₐvₗᵢₙₖ,v_{B}=d_{b}vₗᵢₙₖ,v_{C}=d_{c}vₗᵢₙₖ (1)

where dₐ, d_{b}, and d_{c} are the duty cycles for the three phase legs. vₗᵢₙₖ is the intermediate DC-link voltage.

By separating the voltage sources into DM and CM parts as listed in (2) to (4) below, low-frequency circuit model shown in FIG. 5A can be redrawn in the form shown in FIG. 5B, in which:

v_{acDM}=v_{A}−v_{B}=(dₐ−d_{b})vₗᵢₙₖ (2)

v_{acCM}=0.5×(v_{A}+v_{B})=0.5×(dₐ+d_{b})vₗᵢₙₖ, and (3)

v_{gDM}=v_{g},v_{gCM}=0. (4)

The CM sources are defined with respect to the negative DC-link. If the AC input is symmetric, v_{gcm} from the AC grid is zero. The negative DC-link voltage, which is the voltage across Cₚ can be expressed in (5) by using superposition and only considering the CM variables. It has the same low-frequency value as the negative DC bus voltage, thus:

v_{bus-}=vₗᵢₙₖ₋=−v_{acCM} (5)

Equation (5) shows that the negative DC bus voltage can be controlled by controlling the AC-DC stage CM voltage, which is a function of the duty cycles of the AC-DC stage. It also shows that the DC-DC stage does not influence the negative dc bus voltage. Based on the control targets of the DM and CM voltages, the following two expressions (6) and (7) are found for the AC-DC stage:

$$\begin{matrix}{v}_{acDM} \approx {v}_{gDM} and & ( 6 ) \\ {v}_{bus -} = - {v}_{acCM} = - \frac{{v}_{dc}}{2} . & ( 7 )\end{matrix}$$

Equation (6) means that the AC DM voltage roughly tracks the AC grid voltage to generate a sinusoidal AC current. Equation (7) means that the target of CM voltage control is to regulate the negative DC bus voltage by controlling the AC-DC stage CM voltage.

If the original duty cycles from the AC current loop are defined as:

dₐ=0.5+d_{DM} and (8)

d_{b}=0.5−d_{DM} (9)

then after adding d_{CM} to both dₐ and d_{b}:

dₐ=0.5+d_{DM}+d_{CM} and (10)

d_{b}=0.5−d_{DM}+d_{CM} (11)

Combining (2), (3), (6), and (7) gives

$$\begin{matrix}{d}_{DM} = \frac{1}{2} ( {d}_{a} - {d}_{b} ) = \frac{{v}_{g}}{2 {v}_{link}} and & ( 12 ) \\ {d}_{CM} = \frac{1}{2} ( {d}_{a} + {d}_{b} ) - 0.5 = \frac{{v}_{dc}}{2 {v}_{link}} - 0.5 . & ( 13 )\end{matrix}$$

Equation (12) is related to the DM duty cycle needed to control the AC current. Equation (13) is related to the necessary CM duty cycle to control the positive and negative DC bus voltages for symmetry to ground. In one example case, the summation of the DM and CM duty cycles is limited between 0 and 1. In other words, the sum of d_{DM} and d_{CM} should always satisfy:

|d_{DM}|+|d_{CM}|<0.5. (14)

Substituting (12) and (13) into (14) gives:

$$\frac{\vert {v}_{g\_max} \vert}{2 {v}_{link}} + \vert \frac{{v}_{dc}}{2 {v}_{link}} - 0.5 \vert < 0.5 , \qquad ( 15 )$$

where v_{g}_{_}ₘₐₓ is the amplitude of the DC grid voltage.

The solution of (15) gives:

$$\begin{matrix}\vert {v}_{g\_max} \vert < {v}_{dc} < {v}_{link} or & ( 16 ) \\ \frac{{v}_{dc} + \vert {v}_{g\_max} \vert}{2} < {v}_{link} < {v}_{dc} . & ( 17 )\end{matrix}$$

Considering the topology of the example interface converter system 300, the DC-link voltage is always higher than the AC and DC terminals voltage. Equation (16) should be satisfied but is a weak requirement. When the input AC-DC stage is a boost type converter, the DC-link voltage is always higher than the peak voltage of the AC input. If the DC-DC stage is a buck type converter that steps down the DC-link voltage, the requirement that DC voltage be less than the DC-link voltage is also satisfied. The only condition is the AC peak voltage should be smaller than the DC bus voltage. This is satisfied, for example, if the AC peak voltage is 340 V (240\sqrt{2}) and the DC bus voltage is 380 V. In that case, the example has sufficient margin to inject the CM duty cycle and control the DC bus CM voltage.

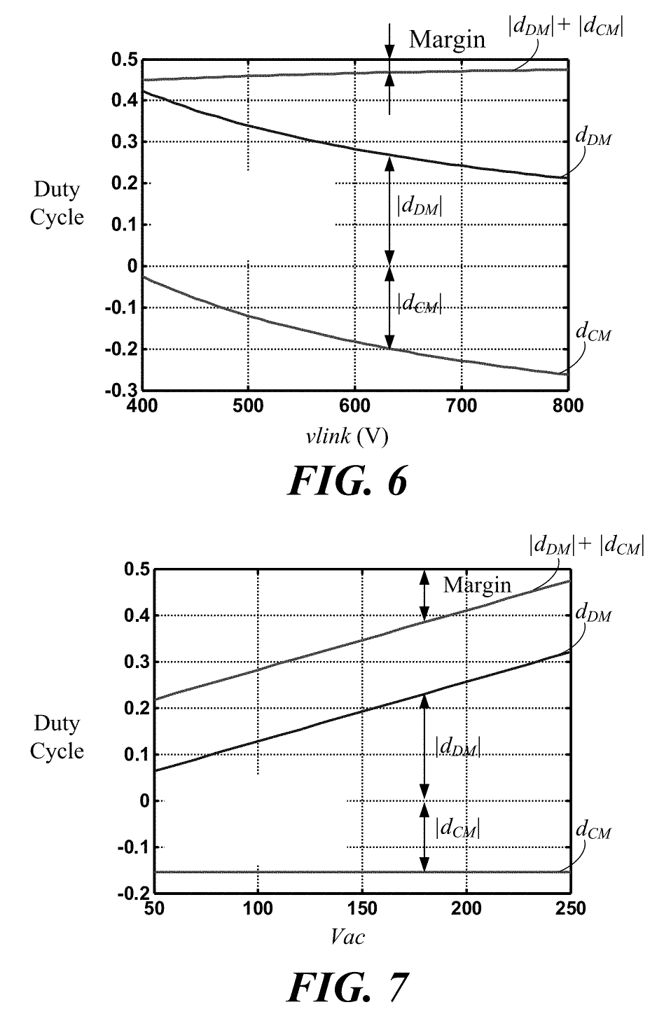

FIG. 6 illustrates the impact from the DC-link voltage on the CM duty cycle injection margin by evaluating (12) and (13), and FIG. 7 illustrates the impact from the AC voltage on the CM duty cycle injection margin by evaluating (12) and (13). Changes to the DC-link voltage vlink do not influence the control margin significantly. Although increasing the DC-link voltage reduces the required DM duty cycle, the injected CM duty cycle is increased. The sum of these two (e.g., |d_{DM}|+|d_{CM}|) does not change much as vlink changes. On the contrary, the AC input voltage Vac has a larger impact on the control margin. A smaller AC input voltage Vac leads to a larger control margin, and a larger AC input voltage Vac leads to a larger control margin

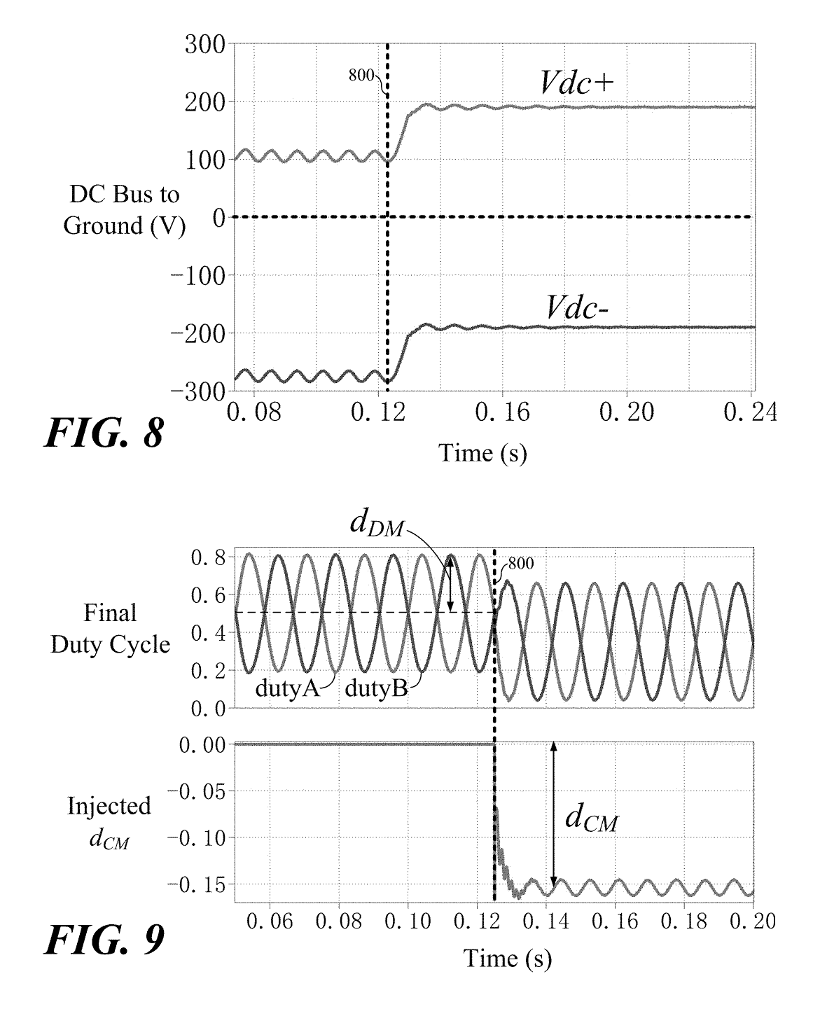

FIG. 8 illustrates an example time domain simulation with a 550 V DC-link voltage and a 240 V split-phase AC input voltage, and FIG. 9 illustrates an example duty cycle before and after enabling CM voltage control for the example case in FIG. 8. As shown in FIG. 8, after enabling the CM voltage control at point 800, the DC bus voltage is controlled to be symmetric to the ground. Further, as shown in FIG. 9, a constant CM duty cycle with a small AC ripple is injected.

As FIG. 3 shows, the AC grounding can be asymmetric. The equivalent circuit in FIG. 5A is still valid in that case except the CM grid voltage is no longer zero and needs to be compensated by the control, such that:

$${v}_{gCM} = \frac{1}{2} ( {v}_{g} + 0 ) = \frac{1}{2} {v}_{g} . \qquad ( 18 )$$

The corresponding control requirement and operating range are changed to:

$$\begin{matrix}{v}_{link -} = - {v}_{CMac} + \frac{{v}_{g}}{2} = - \frac{{v}_{dc}}{2} and & ( 19 ) \\ \frac{\vert {v}_{g\_max} \vert}{2 {v}_{link}} + \vert \frac{{v}_{dc} + {v}_{g\_max}}{2 {v}_{link}} - 0.5 \vert < 0.5 . & ( 20 )\end{matrix}$$

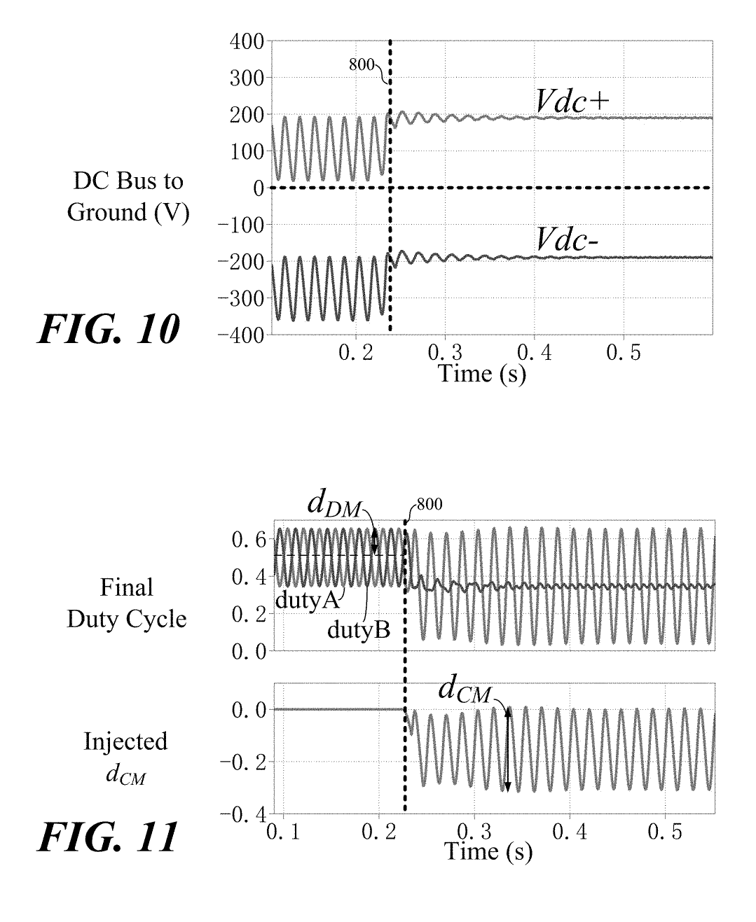

In the context of asymmetric AC grounding, FIG. 10 illustrates an example time domain simulation with a 380 V DC-link voltage and a 120 V asymmetric AC input, and FIG. 11 illustrates an example duty cycle before and after enabling CM voltage control for the example simulation shown in FIG. 10. Without the CM voltage control, the DC bus voltage has around 170 V CM voltage ripple. As shown in FIG. 11, the injected duty cycle is no longer predominantly DC but now sinusoidal as compared to FIG. 9. As also shown in FIG. 11, the shape of the duty cycle for the two phase legs is completely different, particularly as compared to FIG. 9. Since d_{CM} has a large ripple, the theoretical analysis only provides a rough estimation and can be verified by simulation.

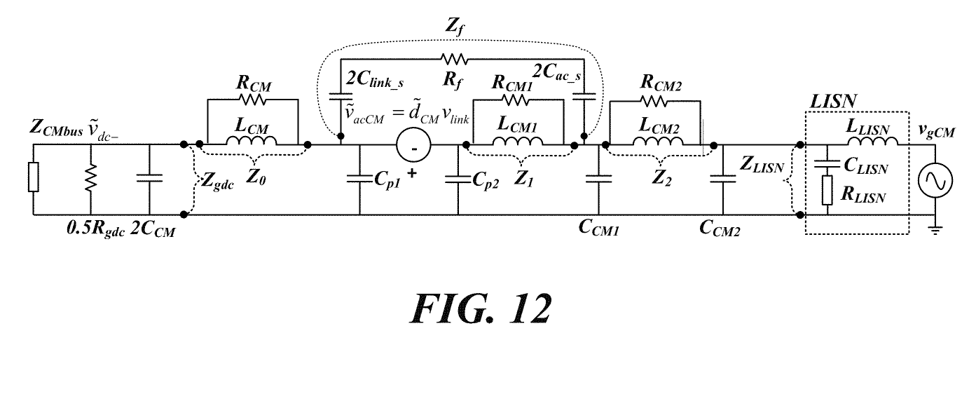

Within its operating range, a closed-loop compensator can be designed to control the DC bus to ground voltage. In that context, FIG. 12 illustrates an example equivalent circuit of the interface converter system shown in FIG. 3 with the floating filter. The physical meaning of each component in FIG. 12 can be found with reference to the description for FIG. 3. A line stabilization network (LISN) is placed between the converter and the AC grid to bypass the uncertainty of the line impedance from the AC side transformer and utility. Cₚ₁ and Cₚ₂ are parasitic capacitances to the ground.

To simplify the derivation of small-signal transfer functions, various impedances in FIG. 12 are defined as follows:

Zₜₒₜₐₗ=Z₂+Z_{LISN}Z_{gdc}+Z₀ (21)

Then, the transfer function from the controllable CM source to the negative DC bus voltage can be expressed as:

$${\tilde{v}}_{dc -} = - {\tilde{v}}_{acCM} \frac{{Z}_{f} ‖ {Z}_{total}}{{Z}_{1} + {Z}_{f} ‖ {Z}_{total}} \frac{{Z}_{gdc}}{{Z}_{total}} . \qquad ( 22 )$$

Combining (3) and (13), the transfer function from CM duty cycle to CM voltage source can be expressed as:

\tilde{v}_{acCM}\tilde{d}_{CM}vₗᵢₙₖ (23)

Then the final power stage transfer function from injected CM duty cycle to negative bus voltage is:

$${\tilde{v}}_{dc -} = - {\tilde{d}}_{CM} {v}_{link} \frac{{Z}_{f} ‖ {Z}_{total}}{{Z}_{1} + {Z}_{f} ‖ {Z}_{total}} \frac{{Z}_{gdc}}{{Z}_{total}} . \qquad ( 24 )$$

To validate the model, online transfer function measurements were executed on a hardware prototype with a digital signal processor (DSP). The switching frequency was set to 20 kHz. The passive parameters for the model are listed in TABLE I below.

TABLE I
FILTER PARAMETERS

| | Symbol | Value | |
|---|---|---|---|
| AC filters | L_{CM1} | 3.54 | mH |
| | R_{CM1} | 10 | kΩ |
| | L_{CM2} | 17 | mH |
| | R_{CM2} | 8 | kΩ |
| | C_{CM1} | 1 | nF |
| | C_{CM2} | 1 | nF |
| | LISN | 50 μH, 50 Ω, | |
| | | 0.1 μF | |
| DC filters | L_{CM} | 12.5 | mH |
| | R_{CM} | 10.5 | kΩ |
| | C_{CM} | 10 | nF |
| | R_{gdc} | 100 | kΩ |
| Floating filter | C_{ac}_{_{—}}ₛ | 5.6 | μF |
| | R_{f} | 5 | Ω |
| | Cₗᵢₙₖ_{_{—}}ₛ | 50 | μF |

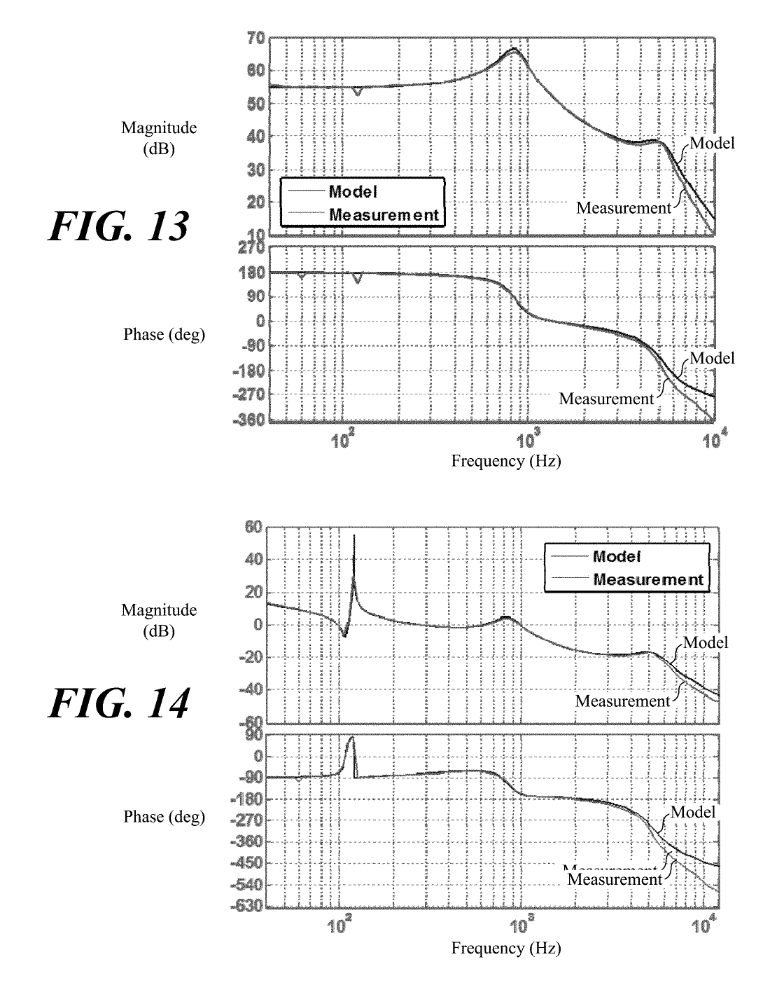

In the model measurement, the DSP injects a series of perturbations with different frequencies to the power stage and measures the response. The information of the perturbation and response is sent back to the host computer for calculation and graphing. In that context, FIG. 13 illustrates the measured power stage transfer function from the CM duty cycle to the negative DC bus voltage compared with the modeled result according to various aspects of the embodiments. FIG. 14 illustrates measured compared to modeled results for the loop gain with resonant controller according to various aspects of the embodiments. The measured and modeled results align well up to about half the switching frequency of 20 kHz.

From the power stage transfer function, two resonant peaks at 850 Hz and 5 kHz are observed. The resonant peaks are from the resonance of the CM filters. The peak at 850 Hz is caused by the floating filter, which consists of L_{CM1}, C_{ac}_{_}ₛ, and Cₗᵢₙₖ_{_}ₛ. It causes a 180 degree phase drop and is near the crossover frequency. This needs to be compensated by the control loop zeros. There is also a high-frequency peak at 5 kHz. This peak is caused by the resonance of the AC and DC side CM filters because the AC and DC sides are connected by the ground. The AC side choke L_{CM2}, in series with the DC side choke L_{CM}, resonant with the DC side grounding capacitor C_{CM}. Though the grounding capacitance is only several nano-farad, the total CM inductance is relatively large. This frequency is above the crossover frequency but also needs consideration. During this resonant peak, the gain curve goes up and can cross the 0 dB line again to cause instability. In the control loop design, poles need to be placed before the second resonance frequency to prevent the resonant peak from going back to the 0 dB line.

With the small-signal model, the multi-pole multi-zero controller (H_{CM}) can be designed based on the gain and phase margin requirement. In one example case, the final H_{CM} parameters are shown in (25) and (26) below. The closed-loop gain has a 9.74 dB gain margin and a 35.71 degree phase margin. The control bandwidth is around 1 kHz. Again, the model and measurement result are compared in FIGS. 13 and 14. The peak at 120 Hz is from the resonant controller to suppress the double-line-frequency ripple. The sag before the peak is from the parallel of integrator and the resonant controller.

$$\begin{matrix}{H}_{CM} = - 0.00242 \times \frac{( s + 4.37 \times {10}^{3} ) ( s + 6.32 \times {10}^{3} )}{s ( s + 3.17 \times {10}^{4} )} & ( 25 ) \\ {R}_{CM} = - 0.5 \times \frac{s}{{s}^{2} + 0.5 s + {( 2 π \times 120 )}^{2}} & ( 26 )\end{matrix}$$

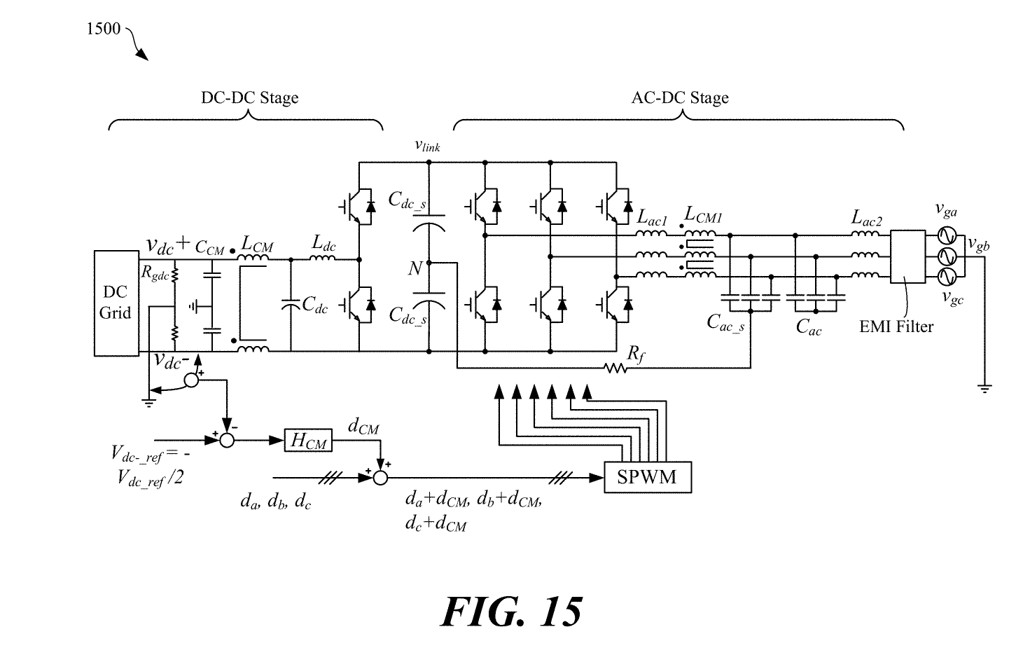

Turning to other embodiments, in high power cases, the AC-DC stage can be fulfilled by a three-phase structure. As to an example three-phase system, FIG. 15 illustrates three-phase cascaded AC-DC interface converter system 1500 according to various examples described herein. The AC-DC stage regulates the DC-link voltage and AC current. The DC-DC stage steps down the DC-link voltage to a required DC bus voltage. In this two-stage structure, the front-end AC-DC stage can also be used to control the DC bus CM voltage like in the single-phase case shown in FIG. 3.

The modulation scheme for three-phase converters can be either carrier-based synchronized pulse width modulation (SPWM) or space vector modulation (SVM). The benefits of SVM are relatively better DC-link voltage utilization and the possibility of reducing switching loss. However, SVM generates a low-frequency CM voltage on the DC-link (e.g. third order harmonic), which is not good for the connection of the DC grid. On the other hand, SPWM shows a symmetric and constant CM voltage on the DC-link.

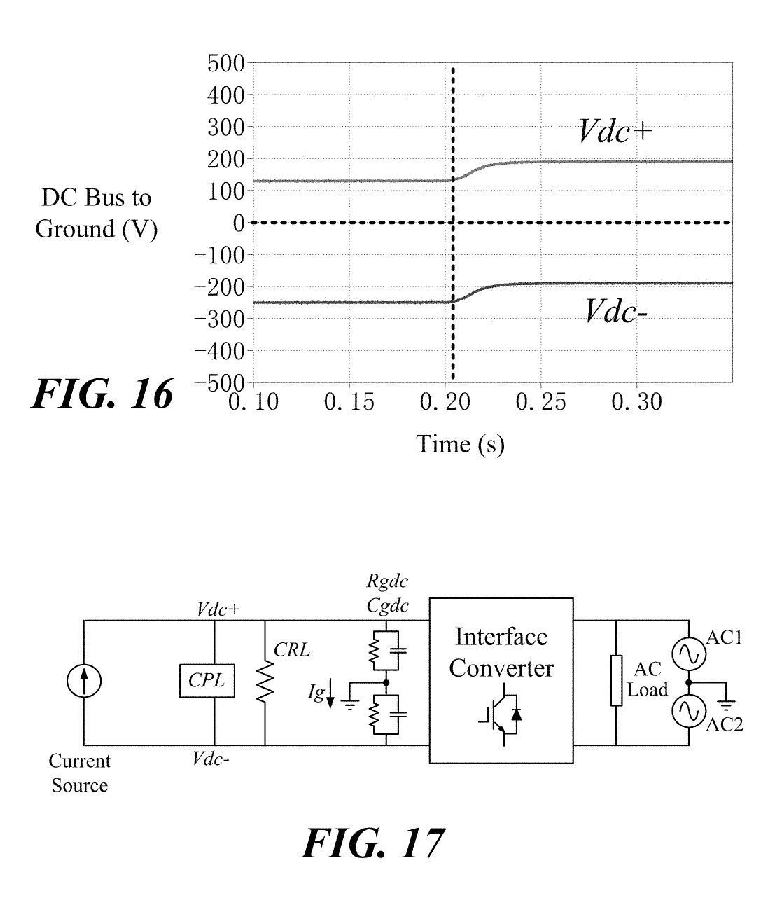

As a variation on the single-phase case shown in FIG. 3, the control scheme for the three-phase cascaded AC-DC interface converter system 1500 is shown in FIG. 15. FIG. 15 thus shows another example of how the aspects of CM voltage control described herein can be applied to other topologies and designs of interface converter systems. The CM voltage control loop generates the required d_{CM} by comparing the negative DC bus voltage with its reference (e.g., V_{dc-}_{_}_{ref}). The injected duty cycle d_{CM} is added to the duty cycle control signals dₐ, d_{b}, and d_{c} for the phase legs of the bridge converter of the AC-DC stage. The final DC bus voltage is symmetric to the ground as shown in FIG. 16. In the three-phase case, there is no double-line-frequency voltage ripple on the DC bus so the resonant controller can be unnecessary.

The proposed low-frequency CM voltage control method was verified using a 10 kW single-phase bidirectional AC-DC converter. The experiment setup is shown in FIG. 17. To accomplish bidirectional power flow, sources and loads are connected at both sides of the AC-DC converter. On the AC side, the converter is connected to a grid simulator with some AC loads. On the DC side, a resistor bank is paralleled with electronic loads. The electronic loads can be programmed to work in either constant resistive load CRL or constant power load CPL mode. A current source is connected to the DC bus to mimic the output energy from renewable sources, for example, since they usually work in maximum power point tracking mode and do not regulate the bus voltage. When the injected current is smaller than the local DC load consumption, the converter works in rectifier mode. When the renewable energy is greater than the local load, the extra energy is sent back to the AC grid, and the converter works in regeneration mode. The CM filter parameters are listed in TABLE I above.

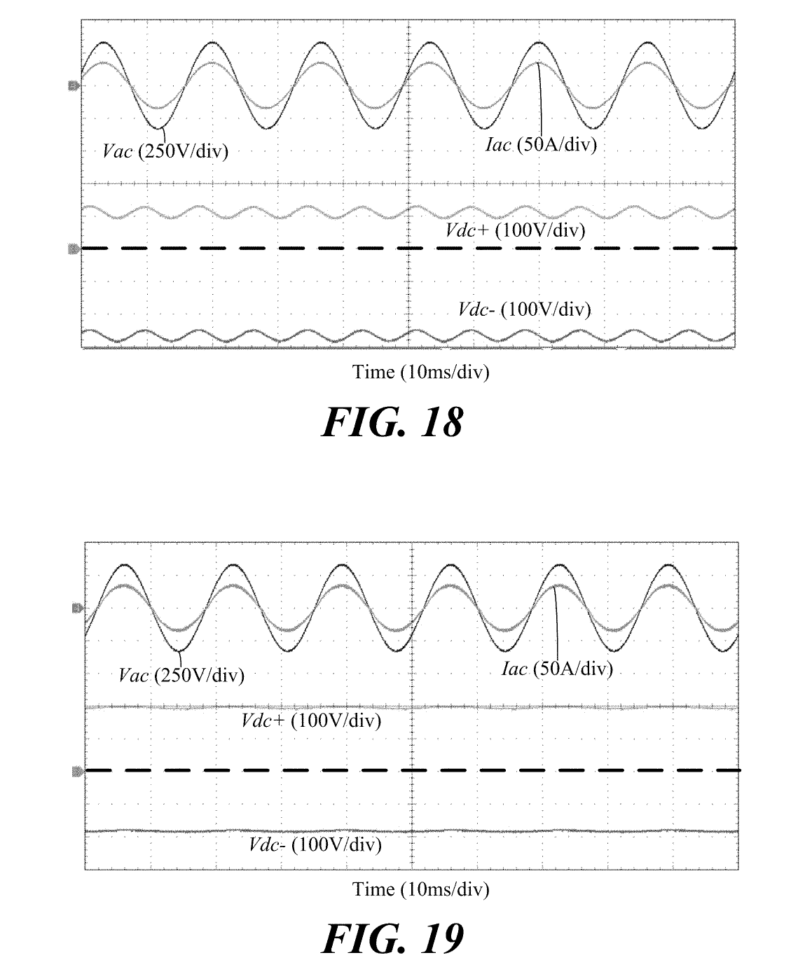

FIGS. 18 and 19 illustrate steady-state AC voltage, AC current, and positive and negative DC bus voltages, with and without the CM voltage control, respectively, for the empirical test setup. After enabling the CM voltage control, the DC bus voltage is adjusted to be symmetric to the ground as shown in FIGS. 18 and 19. The low-frequency ripple is also suppressed.

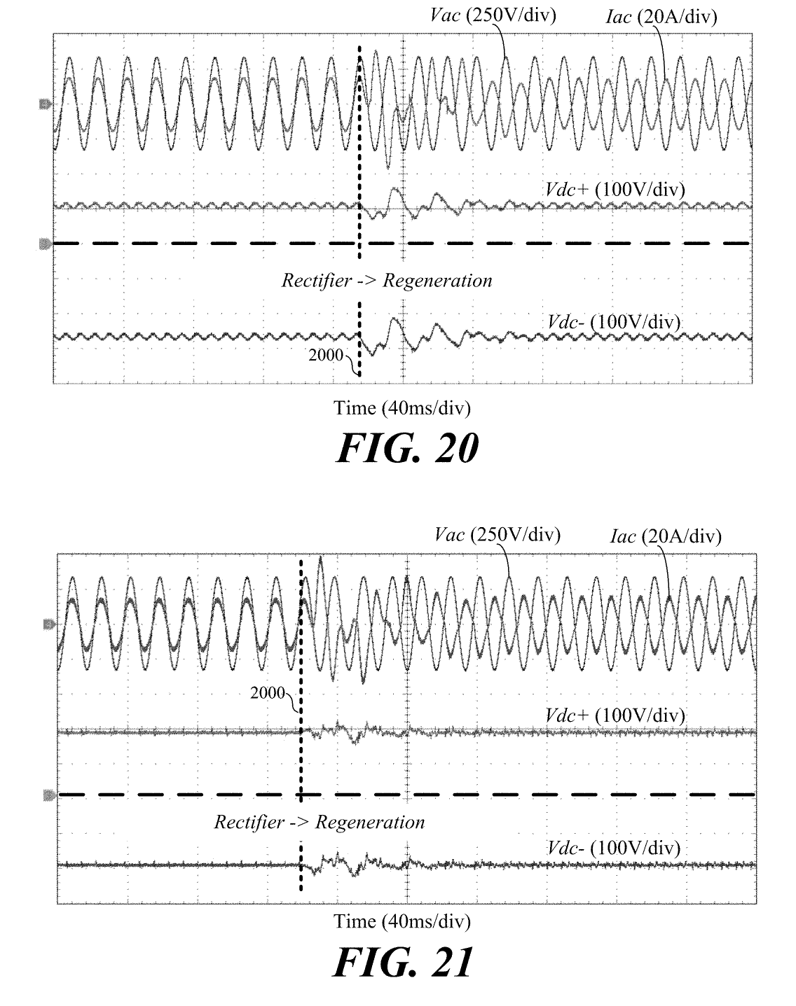

Because the empirical test setup is a bidirectional converter, the transition between rectifier and regeneration modes is also tested with and without the CM control. FIGS. 20 and 21 illustrate the transition between rectifier and regeneration modes with and without CM control, respectively, for the empirical test setup according to various aspects of the embodiments. At the transition time 2000, a 5 kW CPL is suddenly disconnected from the DC bus. The DC side has around 2.5 kW extra power which is sent to the grid. In both cases, the transition is stable. But the transient CM voltage spike is smaller with the CM voltage control.

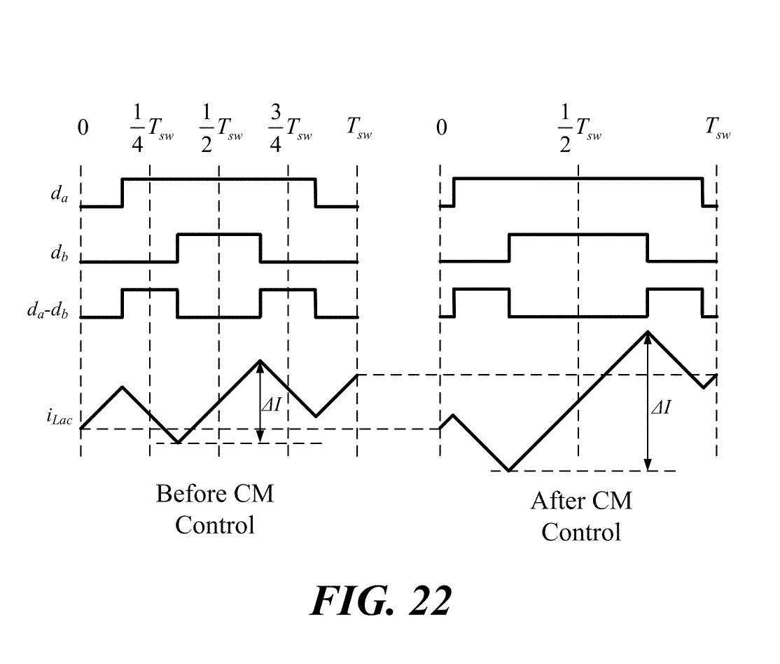

The CM duty cycle injection does have some impact on the grid side AC current. The amplitude of the switching frequency current ripple increases some, which can be observed by comparing the AC current in FIGS. 20 and 21. The reason for this can be explained by looking at the distribution of the on and off time for the power devices within each switching period. For a single-phase full-bridge converter, the unipolar modulation has a small current ripple because it not only doubles the equivalent switching frequency but also evenly distributes the on and off time. When the CM duty cycle is injected, though the switching frequency is still doubled, the distribution of the on and off time is not as even as before. This leads to the increase of DM peak to peak current ripple. As shown in FIG. 22, although the current start and end points are the same with and without the CM control, the peak to peak current ripple is different. This can be solved by properly designing the AC side DM filters.

FIGS. 23A-23G illustrate example topologies and designs of interface converter systems used between different types of electrical systems. FIG. 23A illustrates a general case of an interface converter system 2300 coupled between a first electrical system 2301 and a second electrical system 2302. The first electrical system 2301 can include a power source, such as an AC system grid having any number of phase legs, a DC system grid having any number of phase legs, or another power source, a load, or a combination of one or more loads and power sources. Similarly, the second electrical system 2302 can include a power source, such as an AC system grid having any number of phase legs, a DC system grid having any number of phase legs, or another power source, a load, or a combination or one or more loads and power sources.

In the example shown in FIG. 23A (as with the other examples described herein), the interface converter system 2300 may not electrically isolate the first electrical system 2301 from the second electrical system 2302 (e.g., the interface converter system 2300 is transformer-less). Thus, the first electrical system 2301 and the second electrical system 2302 can share a common ground and, in some cases, ground leakage current can be exchanged between them. Further, a CM filter similar to the CM filter described above with reference to FIG. 3 can be electrically coupled between one or more of the first electrical system 2301, the second electrical system 2302, and the interface converter system 2300.

The interface converter system 2300 can be embodied as a unidirectional or bidirectional interface converter system. Thus, the interface power converter system 2300 can include one or more power converter stages. Examples of unidirectional power converter stages are shown in FIGS. 23B-23D. More particularly, FIG. 23B illustrates a single stage converter interfacing two DC power systems with different voltages, FIG. 23C illustrates a single stage converter interfacing a DC power system and a single phase AC power system, and FIG. 23D illustrates a single stage converter interfacing a DC power system and a multi-phase (i.e., three phase) AC power system. Examples of bidirectional converters including more than one power converter stage are shown in FIGS. 23E-23G. More particularly, FIG. 23E illustrates a dual stage converter interfacing a DC power system with a single phase AC power system, FIG. 23F illustrates a dual stage converter interfacing a single phase AC power system with a multi-phase (i.e., three phase) AC power system, and FIG. 23G illustrates a dual stage converter interfacing two multi-phase AC power systems.

Referring again to FIG. 23A, the topology of the interface converter system 2300 (e.g., among those shown in FIGS. 23B-D or others) can depend upon whether the interface converter system 2300 bidirectionally converts power between the first electrical system 2301 and the second electrical system 2302 or unidirectionally converts power from one of the first electrical system 2301 or the second electrical system 2302 to the other. The topology can also depend upon the number of phase legs of the first electrical system 2301 and/or the second electrical system 2302. Depending on the number of phase legs (and other factors), the interface power converter 2300 can include one or more half-bridges, full-bridges, or other topologies of power converters.

The system shown in FIG. 23A may exhibit any of the problems described herein, such as ground leakage current, asymmetry between bus output voltages at the first electrical system 2301 or the second electrical system 2302, low-frequency ripple at the bus output voltages of the first electrical system 2301 or the second electrical system 2302, or others. To help address those problems (and others), the interface converter system 2300 can include a power converter control loop including a controller configured to generate a plurality of differential mode duty cycle control signals for controlling a differential mode voltage generated by the interface converter system 2300 by switching power switches in the interface converter system 2300. The interface converter system 2300 can also include a power converter control loop configured to sense a bus voltage (e.g., bus to ground voltage) at one or both of the first electrical system 2301 and the second electrical system 2302, develop a CM control signal based on the bus voltage, and adjust the plurality of differential mode duty cycle control signals based on the CM control signal as described herein.

The components described herein, including the AC-DC stage feedback loop, the CM voltage controllers, and the resonant controllers, can be embodied in the form of hardware, as software components that are executable by hardware, or as a combination of software and hardware. If embodied as hardware, the components described herein can be implemented as a collection of discrete analog, digital, or mixed analog and digital circuit components. The hardware can include one or more discrete logic circuits, microprocessors, microcontrollers, or DSPs, application specific integrated circuits (ASICs), programmable logic devices (e.g., field-programmable gate array (FPGAs), or complex programmable logic devices (CPLDs)), among other types of processing circuitry.

The microprocessors, microcontrollers, or DSPs, for example, can execute software to perform the control aspects of the embodiments described herein. Any software or program instructions can be embodied in or on any suitable type of non-transitory computer-readable medium for execution.

Example computer-readable mediums include any suitable physical (i.e., non-transitory or non-signal) volatile and non-volatile, random and sequential access, read/write and read-only, media, such as hard disk, floppy disk, optical disk, magnetic, semiconductor (e.g., flash, magneto-resistive, etc.), and other memory devices. Further, any component described herein can be implemented and structured in a variety of ways. For example, one or more components can be implemented as a combination of discrete and integrated analog and digital components.

The above-described examples of the present disclosure are merely possible examples of implementations set forth for a clear understanding of the principles of the disclosure. Many variations and modifications can be made without departing substantially from the spirit and principles of the disclosure. All such modifications and variations are intended to be included herein within the scope of this disclosure and protected by the following claims.

Therefore, the following is claimed:

1. An interface converter system, comprising:
a power converter electrically coupled between a direct current (DC) power system and an alternating current (AC) power system, the power converter comprising a plurality of power switches;
a high frequency common mode (CM) filter used with the power converter to attenuate high frequency CM noise;
a power converter control loop comprising a controller configured to generate a plurality of differential mode duty cycle control signals for controlling a differential mode voltage generated by the power converter by switching the plurality of power switches in the power converter; and
a CM control loop configured to sense a bus to ground voltage at one of the DC power system or the AC power system, develop a CM control signal based on the bus to ground voltage, and adjust the plurality of differential mode duty cycle control signals based on the CM control signal.

2. The interface converter system according to claim 1, wherein the adjustment of the plurality of differential mode duty cycle control signals based on the CM control signal reduces ground leakage current through a common ground between the AC power system and the DC power system.

3. The interface converter system according to claim 1, wherein the adjustment of the plurality of differential mode duty cycle control signals based on the CM control signal reduces low-frequency ripple on the bus to ground voltage generated by the power converter at the DC power system.

4. The interface converter system according to claim 1, wherein the adjustment of the plurality of differential mode duty cycle control signals based on the CM control signal reduces asymmetry between bus output voltages at the DC power system.

5. The interface converter system according to claim 1, wherein the CM control loop comprises a proportional integral (PI) or multi-pole multi-zero CM voltage controller.

6. The interface converter system according to claim 5, wherein the CM control loop further comprises a resonant controller coupled in parallel with the PI or the multi-pole multi-zero CM voltage controller.

7. An interface converter system, comprising:
a first power converter electrically coupled between a first power system and an interface link;
a second power converter electrically coupled between a second power system and the interface link, the second power converter sharing a common ground with the first power converter;
a first power converter control loop comprising a controller configured to generate a duty cycle control signal to control the first power converter; and
a CM control loop configured to sense a bus to ground voltage at the second power system, develop a CM control signal based on the bus to ground voltage, and adjust the duty cycle control signal based on the CM control signal.

8. The interface converter system according to claim 7, wherein the adjustment of the duty cycle control signal based on the CM control signal reduces ground leakage current through a common ground between the first power system and the second power system.

9. The interface converter system according to claim 7, wherein the adjustment of the duty cycle control signal based on the CM control signal reduces low-frequency ripple on and reduces asymmetry between bus output voltages at the second power system.

10. The interface converter system according to claim 7, further comprising a common mode (CM) filter coupled between the first power converter and the interface link to attenuate high frequency CM noise.

11. The interface converter system according to claim 7, wherein:
the first power converter comprises at least one phase leg to generate a differential mode voltage at the interface link;
the controller of the first power converter control loop is further configured to generate at least one duty cycle control signal for the at least one phase leg; and
the CM control loop is further configured to adjust the at least one duty cycle control signal based on the CM control signal.

12. The interface converter system according to claim 11, wherein the CM control loop comprises a summer that adds at least a portion of the CM control signal to the at least one duty cycle control signal.

13. The interface converter system according to claim 7, wherein the CM control loop comprises a proportional integral (PI) or a multi-pole multi-zero CM voltage controller.

14. The interface converter system according to claim 13, wherein the CM control loop further comprises a resonant controller coupled in parallel with the PI or the multi-pole multi-zero CM voltage controller.

15. An interface converter system, comprising:
an alternating current to direct current (AC-DC) converter electrically coupled between an AC power system and an interface link;
a DC-DC converter electrically coupled between a DC power system and the interface link;
an AC-DC control loop configured to generate a control signal to control the AC-DC converter; and
a common mode (CM) control loop configured to develop a CM control signal based on a voltage at the DC power system and adjust the control signal based on the CM control signal.

16. The interface converter system according to claim 15, wherein:
the AC-DC converter shares a common ground with the DC-DC converter; and
the adjustment of the control signal based on the CM control signal reduces ground leakage current through the common ground.

17. The interface converter system according to claim 15, wherein the adjustment of the control signal based on the CM control signal reduces low-frequency ripple on and reduces asymmetry between bus output voltages at the DC power system.

18. The interface converter system according to claim 15, further comprising a common mode (CM) filter coupled between the AC-DC control loop and the interface link to attenuate high frequency CM noise.

19. The interface converter system according to claim 18, wherein the CM control loop comprises a proportional integral (PI) or a multi-pole multi-zero CM voltage controller.

20. The interface converter system according to claim 19, wherein the CM control loop further comprises a resonant controller coupled in parallel with the PI or the multi-pole multi-zero CM voltage controller.
